(19) United States
(12) Patent Application Publication
(10) Pub. No.: US 2004/0251854 A1
(43) Pub. Date: Dec. 16, 2004

(54) Power supply for lighting

(76) Inventors: Tomoaki Matsuda, Tokyo (JP); Tatsuru Iwasa, Tokyo (JP)

Correspondence Address: GALLAGHER & LATHROP, A PROFESSIONAL CORPORATION, 601 CALIFORNIA ST, SUITE 1111, SAN FRANCISCO, CA, 94108, US

(21) Appl. No.: 10/865,551

(22) Filed: Jun. 9, 2004

(30) Foreign Application Priority Data
Jun. 13, 2003 (JP) 2003-168730

(51) Int. Cl. H05B 37/02

(52) U.S. Cl. 315/291; 315/247; 315/224

(57) ABSTRACT

A switching circuit for turning on/off a DC voltage outputted from a DC/DC converter and a feedback voltage detection circuit for supplying a feedback voltage to the DC/DC converter are controlled in synchronism with each other. In synchronism with a transition of a PWM signal from high level to low level, the switching circuit is immediately turned off as well as a set voltage is also instantaneously supplied from the feedback voltage detection circuit to the DC/DC converter, and in synchronism with a transition of the PWM signal from low level to high level, the switching circuit is immediately turned on thereby to supply a DC voltage charged in the DC/DC converter to a light source as well as the DC/DC converter is caused to start its boosting operation, and a feedback voltage based on a detected voltage is supplied from the feedback voltage detection circuit to the DC/DC converter.

### BACKGROUND OF THE INVENTION

1. Field of the Invention

The present invention relates to a power supply for lighting that controls luminance (quantity of light) of lighting or illumination using a PWM (pulse width modulation) dimming system, and to such power supply for lighting that is suitable for use in lighting, for example, a lighting or illumination system (apparatus) which uses, as its light source, a fluorescent discharge lamp or tube such as a hot cathode fluorescent lamp, a cold cathode fluorescent lamp or the like, a light emitting diode (LED), or the like.

2. Description of the Related Art

As is well known, luminance (quantity of light) of a lighting or illumination system (apparatus) (hereinafter referred to as lighting system) that uses, as its light source, an incandescent lamp, a discharge lamp, a light emitting diode (LED) or diodes, or the like can be controlled by use of a dimmer. In case of a dimmer that controls an output current (voltage) from a power supply for lighting or illumination (hereinafter referred to as power supply for lighting) to adjust luminance of a lighting system, in general, there are used an analog dimming system that controls luminance of a lighting system by changing (increasing or decreasing) the intensity of a current flowing through the light source thereof and a PWM (pulse width modulation) dimming system (which is also called a duty dimming system) that controls luminance of a lighting system by supplying a current pulse of a constant current intensity to the light source thereof and by changing the pulse width (time duration in which the current flows) of the current pulse. There is disclosed in, for example, Japanese Patent Application Unexamined Publication No. 10-112396 (JP, 10-112396, A(1998)) published on Apr. 28, 1998 a dimmer circuit for discharge lamp using both of an analog dimming system and a PWM dimming system.

In case of a lighting system in which a plurality of light emitting diodes is used as its light source, a PWM dimming system is generally used. The reason is that luminance of each of the light emitting diodes is guaranteed only when a current of a constant intensity or value flows therethrough, and if the intensity of a current flowing through each diode should differ from such constant current intensity, luminance of each diode is independently changed depending upon its characteristic which would differ from one another. That is, in case of increasing or decreasing intensity of an output current from a power supply for lighting using a dimmer of analog dimming system, intensity of a current flowing through each of the plurality of light emitting diodes is changed beyond the constant current intensity that is guaranteed, and hence luminances of these diodes are independently changed depending upon their individual characteristics. For that reason, in case of using an analog dimming system dimmer, it is difficult to control luminances of a plurality of light emitting diodes uniformly.

On the contrary, in case of controlling intensity of an output current from a power supply for lighting using a dimmer of PWM dimming system, only a time duration of a current flowing through each light emitting diode is changed and intensity of the current is constant (only a duty ratio of a current pulse flowing through the light source is changed), and therefore, a current of the constant intensity always flows through each of the plurality of light emitting diodes. Accordingly, it is possible to control luminances of a plurality of light emitting diodes uniformly, and in case of a lighting system in which a plurality of light emitting diodes is used as its light source, there are many cases that a dimmer of PWM dimming system is used.

In case of a dimmer using a PWM dimming system, a PWM signal is applied to the dimmer from the outside in order to turn on/off a current flowing through a light source of a lighting system. For this reason, in the PWM dimming system, response time and accuracy of an output current (voltage) from a power supply for lighting relative to a PWM signal which turns on/off the output current (voltage) become important matters. The reason thereof is that if the response of the output current is slow, that is, the rise time and fall time of the output current relative to a PWM signal are long, an intended output current cannot be obtained in case the duty ratio (duty factor) of the PWM signal is low, that is, in case the time duration of the current flowing through a light source is short, and high accurate luminance control cannot be also attained.

The present invention relates to an improvement in a power supply for lighting using a PWM dimming system in which a PWM signal is applied thereto from the outside.

### SUMMARY OF THE INVENTION

It is an object of the present invention to provide a power supply for lighting using a PWM dimming system in which the response of an output current therefrom is rapid or quick relative to a PWM signal.

In order to accomplish the foregoing object, in an aspect of the present invention, there is provided a power supply for lighting using a PWM dimming system comprising: a PWM signal input terminal to which a PWM signal is to be inputted from the outside; a DC-to-DC converter that converts an input DC voltage to a higher DC voltage of a predetermined voltage value and is provided with means for preserving a boosted DC voltage of a predetermined voltage value; a switching circuit that controls to pass or stop therethrough a DC voltage outputted from the DC-to-DC converter and has a control terminal to which a PWM signal is supplied from the PWM signal input terminal; and a feedback voltage detection circuit that outputs a feedback voltage based on a current flowing through a light source or a set voltage for stopping the operation of the DC-to-DC converter and has a control terminal to which a PWM signal is supplied from the PWM signal input terminal, and wherein the switching circuit operates such that it connects, when the PWM signal supplied to the PWM signal input terminal is at high level, its input end with its output end to output the DC voltage of a predetermined voltage value outputted from the DC-to-DC converter, and disconnects, when the PWM signal is at low level, its input end from its output end to stop outputting the DC voltage of a predetermined voltage value outputted from the DC-to-DC converter; and the feedback voltage detection circuit operates such that it outputs, when the PWM signal supplied to the PWM signal input terminal is at high level, the feedback voltage based on a current flowing through a light source to supply it to the DC-to-DC converter, and outputs, when the PWM signal is at low level, the set voltage for stopping the operation of the DC-to-DC converter to supply it to the DC-to-DC converter.

In a preferred embodiment, the power supply further includes means for detecting a current flowing through a light source. When a PWM signal is at high level, a voltage signal obtained by converting a current detected by the current detection means to a voltage is inputted to the feedback voltage detection circuit so that the detection circuit supplies a feedback voltage based on the inputted voltage signal to the DC-to-DC converter.

The switching circuit connects its input end with its output end in synchronism with a transition of a PWM signal from low level to high level, thereby to output the DC voltage being charged in the DC current preservation means of the DC-to-DC converter to a light source.

The switching circuit may comprise: a first switching element that turns off when a PWM signal is at low level and turns on when the PWM signal is at high level; and a second switching element that turns on/off in synchronism with on/off of the first switching element. The DC voltage outputted from the DC-to-DC converter may be controlled by the second switching element to pass or stop through the switching circuit.

The feedback voltage detection circuit may comprise: a first differential amplifier having an enable terminal; and a second differential amplifier having an enable terminal. A PWM signal may be directly supplied to the enable terminal of the first differential amplifier and an inverted PWM signal of the PWM signal may be supplied to the enable terminal of the second differential amplifier, and the first amplifier may operate only when the PWM signal supplied to the enable terminal thereof is at high level, to output the feedback voltage based on a current flowing through a light source, and the second amplifier may operate only when the PWM signal supplied to the enable terminal thereof is at high level, to output the set voltage for stopping the operation of the DC-to-DC converter.

With the construction as described above, when a transition of a PWM signal from low level to high level occurs, the power supply can rapidly respond thereto to supply a constant current of a predetermined current value to the light source, and yet, during a time duration that the PWM signal is at high level, maintain the current flowing through the light source in a constant current value with high accuracy. In addition, when a transition of the PWM signal from high level to low level occurs, the power supply can rapidly respond thereto to pause or stop application of the DC voltage to the light source as well as to pause or stop the boosting operation of the DC-to-DC converter. Accordingly, in case the duty ratio of the PWM signal is altered, the above-stated operations are carried out at once, and hence the power supply can supply a constant current of a predetermined current value to the light source in stable state during a time duration that the PWM signal is at high level from the time point when the transition of the PWM signal from low level to high level has occurred. Thus, even in case the duty ratio or factor of the PWM signal is low, a constant current of a predetermined current value flows stably through the light source, and so it is possible to control or adjust luminance or quantity of light of the light source with high accuracy.

### BRIEF DESCRIPTION OF THE DRAWINGS

FIG. 1 is a schematic diagram showing an embodiment of a power supply for lighting according to the present invention.

FIG. 2 is a circuit diagram showing one specific circuit connection of the power supply for lighting shown in FIG. 1.

FIG. 3 is a schematic diagram showing a circuit construction of a power supply for lighting in which the dimming of a light source is performed only by turning on/off an output voltage from a DC-to-DC converter.

FIG. 4 is a schematic diagram showing a circuit construction of a power supply for lighting in which the dimming of a light source is performed only by switching a feedback voltage.

FIG. 5 illustrates waveforms of a PWM signal and of output currents from the power supplies for lighting shown in FIGS. 1, 2, 3 and 4 to show current characteristics thereof.

### DETAILED DESCRIPTION OF THE PREFERRED EMBODIMENTS

The preferred embodiment of the present invention will now be described in detail with reference to the accompanying drawings. The present invention may, however, be embodied in many different forms and should not be construed as limited to the embodiment set forth hereinafter; rather, the embodiment is provided so that this disclosure will be thorough and complete, and will fully convey the scope of the invention to those skilled in the art.

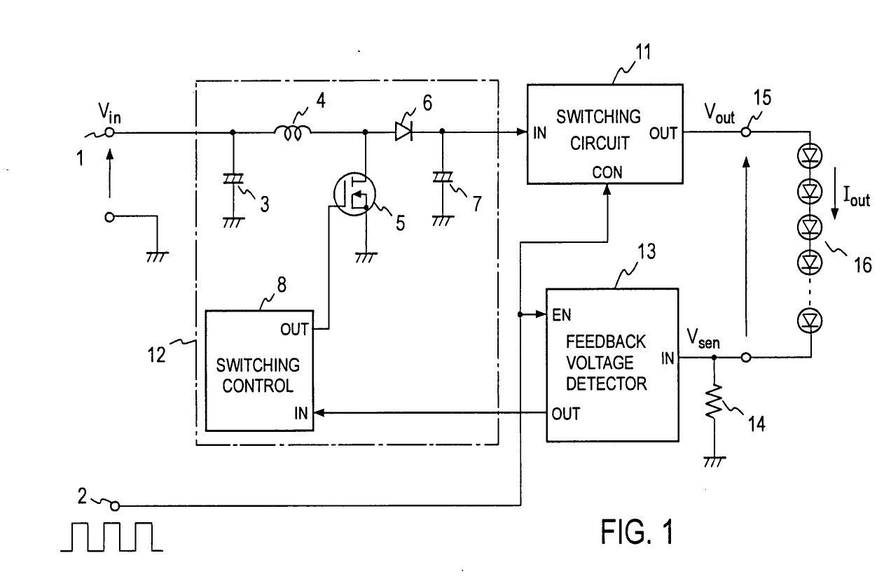

At first, an embodiment of the power supply for lighting according to the present invention will be described in detail with reference to FIG. 1.

As illustrated, the power supply for lighting of this embodiment comprises: a step-up type DC-to-DC converter (hereinafter referred to as DC/DC converter) 12 that converts or boosts an input DC voltage into a higher DC voltage of a predetermined voltage value; a switching circuit 11 that controls to pass or stop therethrough a DC voltage outputted from the DC/DC converter 12; and a feedback voltage detection circuit (detector) 13 that detects a current Iₒᵤₜ flowing through a light source 16 to be connected to the output end OUT of the switching circuit 11 and supplies a feedback voltage based on the detected current to the DC/DC converter 12. In this embodiment, the light source 16 is constituted by a plurality of light emitting diodes connected in series, but it is needless to say that it may be other light source such as a hot cathode fluorescent lamp, a cold cathode fluorescent lamp, or the like.

To the input end of the DC/DC converter 12 is connected an input terminal 1 of the power supply for lighting, to which a predetermined DC voltage Vᵢₙ is inputted from an external power supply. The output terminal 15 of the power supply for lighting is connected to the output end OUT of the switching circuit 11 and the light source 16 is connected between the output terminal 15 and the ground (earth). Accordingly, when the switching circuit 11 is turned on and the DC voltage Vₒᵤₜ is outputted from the output end OUT thereof, the light source 16 goes on (emits light). Further, a resistor 14 for detecting a current Iₒᵤₜ flowing through the light source 16 is connected between the light source 16 and the ground, and when the light source 16 is turned on, there is supplied to the input end IN of the feedback voltage detection circuit 13 as a feedback voltage a voltage Vₛₑₙ(=Iₒᵤₜ×resistance value of the resistor 14) generated across the current detection resistor 14 based on the current Iₒᵤₜ flowing through the resistor 14.

The DC/DC converter comprises: a first capacitor 3 connected between the input end of the converter 12 and the ground; a coil 4 and a rectifier diode 6 polarized as shown in the figure, they being connected in series between the input terminal 1 and the output end of the converter 12; a transistor (an N-channel MOSFET in this embodiment) 5 connected between the ground and a node of the coil 4 and the diode 6; a second capacitor 7 connected between the ground and a node of the diode 6 and the output end of the converter 12; and a switching control element 8 consisting of an IC (integrated circuit), that controls to turn on/off the transistor 5. Further, the output end OUT of the switching control element 8 is connected to gate of the transistor 5 and the input end IN of the element 8 is connected to the output end OUT of the feedback voltage detection circuit 13. In addition, drain of the transistor 5 is connected to a node of the coil 4 and the diode 6 and source thereof is grounded.

A PWM signal input terminal 2 is connected to the control terminal CON of the switching circuit 11. A PWM signal that is supplied to the power supply for lighting from the outside in order to periodically turn on/off a current flow through the light source 16, is supplied to the control terminal CON of the switching circuit 11 through the PWM signal input terminal 2. At the same time, the PWM signal supplied to the PWM signal input terminal 2 is also supplied to the enable terminal EN of the feedback voltage detection circuit 13.

Next, the operation of the power supply for lighting constructed as discussed above will be explained. When a DC voltage Vᵢₙ of a predetermined voltage value is inputted to the input terminal 1, the DC voltage Vᵢₙ is boosted by the combination of the first capacitor 3, the coil 4, the transistor controlled by the switching control element 8 to be periodically turned on/off, and the rectifier diode 6. The boosted DC voltage is charged in the second capacitor 7. Further, the operation of the DC/DC converter 12 is well known in this technical field, and the detailed explanation thereof will be omitted.

The DC voltage charged in the second capacitor 7 (the DC voltage boosted to a predetermined voltage value) is applied to the input end IN of the switching circuit 11. The switching circuit 11 is arranged such that it connects its input end IN with its output end OUT when a PWM signal supplied to the control terminal CON thereof is at high level and does not connect its input end IN with its output end OUT when the PWM signal is at low level. As a result, only when the PWM signal is at high level, the DC voltage boosted to a predetermined voltage value is supplied through the output end OUT thereof to the output terminal 15 of the power supply for lighting. Consequently, the DC voltage Vₒᵤₜ is applied across the light source 16, and hence a current Iₒᵤₜ of a predetermined current value flows through the light source 16 so that it is turned on (emits light).

The current Iₒᵤₜ flowing through the light source 16 is converted into a voltage by the current detection resistor 14, and this voltage is applied to the input end IN of the feedback voltage detection circuit 13 as a detected voltage Vₛₑₙ. As discussed above, a PWM signal is supplied to the enable terminal EN of the feedback voltage detection circuit 13, and the feedback voltage detection circuit 13 is arranged such that it outputs to its output end OUT a voltage based on the detected voltage Vₛₑₙ being applied to its input end IN (usually, a voltage obtained by amplifying the detected voltage Vₛₑₙ) when the PWM signal is at high level, and that, when the PWM signal is at low level, it outputs to its output end OUT a signal (a voltage signal in this embodiment) which functions to stop the operation of the switching control element 8 of the DC/DC converter 12. Accordingly, when a transition from low to high occurs in the level of the PWM signal being supplied to the enable terminal EN, the voltage based on the detected voltage Vₛₑₙ is outputted from the output end OUT thereof, and is supplied to the input end IN of the switching control element 8. On the contrary, when a transition from high to low occurs in the level of the PWM signal being supplied to the enable terminal EN, the voltage signal that functions to stop the operation of the switching control element 8 is supplied to the input end IN of the switching control element 8 from the output end OUT of the feedback voltage detection circuit 13, and therefore, the DC/DC converter 12 stops its boosting operation.

In this way, in the embodiment, when the level of the PWM signal changes from low to high, the switching circuit 11 is turned on in a moment, and the voltage signal based on the detected voltage Vₛₑₙ is fed back to the switching control element 8 of the DC/DC converter 12 from the feedback voltage detection circuit 13 thereby to cause the DC/DC converter 12 to execute its boosting operation. On the other hand, when the level of the PWM signal changes from high to low, the switching circuit 11 is turned off in a moment, and the voltage signal that functions to stop the operation of the switching control element 8 of the DC/DC converter 12 is instantaneously outputted from the feedback voltage detection circuit 13 and is supplied to the switching control element 8. In other words, “on” operation of the switching circuit 11 is carried out at once in synchronism with the periodic transition of the PWM signal to high level, and likewise, “off” operation of the switching circuit 11 is carried out at once in synchronism with the periodic transition of the PWM signal to low level. On the other hand, the feedback voltage detection circuit 13 feeds back the voltage signal based on the detected voltage Vₛₑₙ to the switching control element 8 of the DC/DC converter 12 in synchronism with the periodic transition of the PWM signal to high level, and supplies thereto the voltage signal that functions to stop the operation of the switching control element 8 in a moment in synchronism with the periodic transition of the PWM signal to low level.

On the contrary, the DC/DC converter 12 starts its boosting operation by the fact that the voltage signal based on the detected voltage Vₛₑₙ is fed back to the switching control element 8 from the feedback voltage detection circuit 13 in synchronism with the periodic transition of the PWM signal to high level, and stops its boosting operation at once in synchronism with the periodic transition of the PWM signal to low level.

As is clear from the foregoing, with the construction of the embodiment discussed above, the switching circuit 11 rapidly or quickly responds to the periodic change in level of the PWM signal with high accuracy. Accordingly, in synchronism with the transition of the PWM signal from low level to high level, the switching circuit 11 is turned on in a moment and is turned off in a moment in synchronism with the transition of the PWM signal from high level to low level. Likewise, the feedback voltage detection circuit 13 also rapidly responds to the periodic change in level of the PWM signal with high accuracy, and when the transition of the PWM signal from high level to low level occurs, the feedback voltage detection circuit 13 outputs, in a moment, the set voltage that functions to stop the operation of the switching control element 8 thereby to cause the DC/DC converter 12 to stop its operation. As a result, the DC voltage of a predetermined voltage value being charged in the second capacitor 7 of the DC/DC converter 12 is not discharged even when the transition of the PWM signal from high level to low level occurs, and hence it is held in the second capacitor 7 during a time duration that the PWM signal is at low level from the time point when the transition of the PWM signal from high level to low level has occurred.

On the contrary, the voltage signal based on the detected voltage Vₛₑₙ is fed back from the feedback voltage detection circuit 13 to the switching control element 8 of the DC/DC converter 12 with a little or slight time delay. However, since the switching control element 8 becomes operative condition at once in synchronism with the transition of the PWM signal from low level to high level as well as the DC voltage of a predetermined voltage value being charged in the second capacitor 7 of the DC/DC converter 12 is instantaneously applied to the light source 16 through the switching circuit 11, the boosting operation of the DC/DC converter 12 goes to stable condition while the DC voltage of a predetermined voltage value being charged in the second capacitor 7 is applied to the light source 16, even if the operation of the DC/DC converter 12 should be unstable in a moment at the start of the operation.

As a result, during a time duration that the PWM signal is at high level from the time point when the transition of the PWM signal from low level to high level has occurred, the stable DC voltage of a predetermined voltage value is applied to the light source 16, and hence the current Iₒᵤₜ flowing through the light source 16 can be maintained in a constant current value with high accuracy. In addition, if the duty ratio of the PWM signal be changed, a time duration that the current Iₒᵤₜ flows through the light source 16 is merely increased or decreased so that the stable current of a constant current value can flow through the light source 16. Accordingly, in case the duty ratio of the PWM signal is low, the stable current of a predetermined constant current value flows through the light source 16 during a time duration that the PWM signal is at high level from the time point when the transition of the PWM signal from low level to high level has occurred. Thus, it is possible to control or adjust luminance or quantity of light of the light source 16 with high precision.

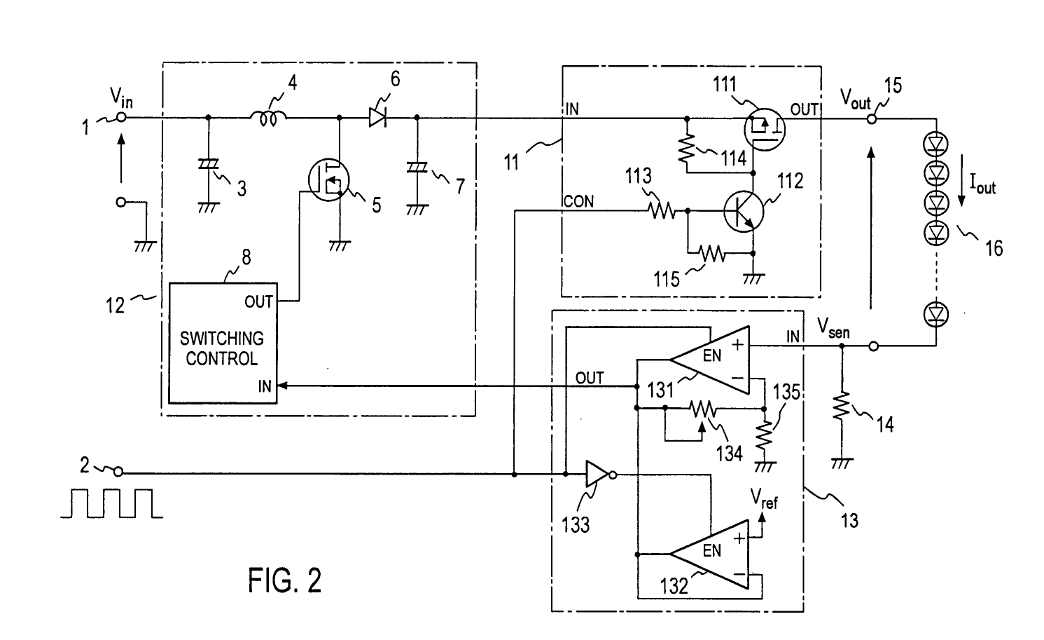

Specific circuit diagrams of the switching circuit 11 and the feedback voltage detection circuit 13 stated above are shown in FIG. 2.

The switching circuit 11 is constructed by a combination circuit of an N-channel MOSFET (metal oxide semiconductor field effect transistor) 111 and a bipolar (npn) transistor 112. The MOSFET 111 has its source connected to the input end of the switching circuit 11 and its drain connected to the output end of the switching circuit 11. Collector and emitter of the bipolar transistor 112 are connected between gate of the MOSFET 111 and the ground, and base of the transistor 112 is connected to the control terminal CON of the switching circuit 11 through a resistor 113. Accordingly, when a PWM signal supplied to the control terminal CON from the PWM signal input terminal 2 changes to high level and the MOSFET is turned on, the DC voltage of a predetermined current value outputted from the DC/DC converter 12 is supplied to the output terminal 15 of the power supply. Further, between source and gate of the MOSFET 111 and between base and emitter of the transistor 112 are connected bias resistors 114 and 115, respectively.

The feedback voltage detection circuit 13 is constructed by a combination circuit of a first and a second differential amplifiers 131 and 132 and an inverter 133. Both the differential amplifiers 131 and 132 are provided with their enable terminals EN, respectively, and the PWM signal input terminal 2 is directly connected to the enable terminal EN of the first differential amplifier 131 and connected to the enable terminal EN of the second differential amplifier 132 through the inverter 133. As a result, to the enable terminal EN of the first differential amplifier 131 is directly supplied a PWM signal, and to the enable terminal EN of the second differential amplifier 132 is supplied a PWM signal inverted by the inverter 133.

The detected voltage Vsen generated across the current detection resistor 14 is inputted to the non-inverting (+) input terminal of the first differential amplifier 131, and to its inverting (−) input terminal is inputted a voltage obtained by dividing an output voltage from the first differential amplifier 13 1 by a voltage divider circuit consisting of a variable resistor 134 and a fixed resistor 135. Since a voltage applied to the inverting input terminal varies by altering the resistance value of the variable resistor 134, it is possible to control the amplification factor (gain) of the first differential amplifier 131 by use of the above-mentioned voltage divider.

The voltage V_{ref} that is set in voltage to stop the operation of the switching control element 8 of the DC/DC converter 12 is inputted to the non-inverting (+) input terminal of the second differential amplifier 132, and its inverting (−) input terminal is directly connected to the output terminal of the second differential amplifier 132. In other words, the second differential amplifier 132 is a voltage follower, and therefore, its gain is 1 (one). Consequently, when the second differential amplifier 132 operates, the set voltage V_{ref} inputted to the non-inverting terminal thereof is outputted as it is.

In the construction discussed above, when a DC voltage Vᵢₙ of a predetermined voltage value is inputted to the input terminal 1, the DC voltage Vᵢₙ is boosted, when a PWM signal applied to the PWM signal input terminal 2 is at high level as well as the switching control element 8 is in operative condition, to a DC voltage of a predetermined voltage value by the boosting operation of the DC/DC converter 12 and charged in the second capacitor 7. When the transition of the PWM signal from high level to low level occurs, the transistor 112 of the switching circuit 11 is turned off in a moment so that the MOSFET 111 is also turned off in a moment, and so the DC voltage being charged in the second capacitor 7 is not supplied to the output terminal 15. At this time, the first differential amplifier 131 does not operate since the PWM signal of low level is applied to the enable terminal EN thereof, and the second differential amplifier 132 operates since the PWM signal of high level is applied to the enable terminal EN thereof. As a result, when the transition of the PWM signal from high level to low level occurs, the set voltage V_{ref} is supplied at once from the feedback voltage detection circuit 13 to the input end IN of the switching control element 8 of the DC/DC converter 12, and hence the switching control element 8 stops its operation in a moment so that the DC/DC converter 12 also stops its boosting operation in a moment. In addition, the charged voltage in the second capacitor 7 is not discharged and held as it is.

When the transition of the PWM signal from low level to high level occurs, the transistor 112 of the switching circuit 11 is instantaneously turned on so that the MOSFET 111 is also immediately turned on in a moment, and so the DC voltage being charged in the second capacitor 7 is supplied to the output terminal 15 at once. As a result, the DC voltage Vₒᵤₜ of a predetermined voltage value is applied across the light source 16, and hence a constant current Iₒᵤₜ of a predetermined current value flows through the light source 16 so that it is turned on (emits light). The current Iₒᵤₜ flowing through the light source 16 is converted into a voltage by the current detection resistor 14, and this voltage is applied to the non-inverting input terminal of the first differential amplifier 131 of the feedback voltage detection circuit 13 as a detected voltage Vₛₑₙ. Since the PWM signal of high level is applied to the enable terminal EN of the first differential amplifier 131, the amplifier 131 operates to amplify the detected voltage Vₛₑₙ, and outputs a feedback voltage corresponding to the detected voltage Vₛₑₙ amplified by a set amplification factor with a little time delay. On the other hand, the second differential amplifier 132 does not operate since the PWM signal of low level is applied to the enable terminal EN thereof, and so the set voltage V_{ref} that functions to stop the operation of the switching control element 8 is not outputted therefrom. As a result, when the transition of the PWM signal from low level to high level occurs, the switching control element 8 immediately goes to operative condition. While the constant current Iₒᵤₜ of a predetermined current value flows through the light source 16 by the DC voltage of a predetermined voltage value being charged in the second capacitor 7, a feedback voltage is supplied from the feedback voltage detection circuit 13 to the switching control element 8 so that it operates stably and hence the DC/DC converter 12 executes its predetermined boosting operation.

In this way, with the circuit construction shown in FIG. 2, in synchronism with the transition of the PWM signal from low level to high level, the DC voltage of a predetermined voltage value being charged in the second capacitor 7 of the DC/DC converter 12 is immediately applied to the light source 16, and the generation of the set voltage V_{ref} is stopped at once. Accordingly, the switching control element 8 goes to operative condition in a moment. In addition, since a feedback voltage corresponding to the detected voltage Vₛₑₙ amplified by a predetermined amplification factor in the feedback voltage detection circuit 13 is supplied therefrom to the switching control element 8 of the DC/DC converter 12 with a little time delay, it is well understood that the boosting operation of the DC/DC converter 12 becomes stable while the constant current Iₒᵤₜ of a predetermined current value flows through the light source 16 by the DC voltage being charged in the second capacitor 7. On the other hand, in synchronism with the transition of the PWM signal from high level to low level, the switching circuit 11 is immediately turned off so that the DC voltage being applied to the light source 16 is broken at once, and the set voltage V_{ref} is also instantaneously supplied from the feedback voltage detection circuit 13 to the switching control element 8 of the DC/DC converter 12. Therefore, it is easily understood that the switching control element 8 stops its operation at once so that the DC/DC converter 12 also stops its boosting operation in a moment. That is, in synchronism with a change in level of the PWM signal, the switching circuit 11 and the feedback voltage detection circuit 12 rapidly respond thereto, and therefore, it is easily understood that “on” operation of the switching circuit 11 and the boosting operation of the DC/DC converter 12 are carried out immediately in synchronism with the periodic transition of the PWM signal to high level, and that “off” operation of the switching circuit 11 and a halt or stop of the boosting operation of the DC/DC converter 12 are carried out immediately in synchronism with the periodic transition of the PWM signal to low level.

As described above, when a transition of a PWM signal from low level to high revel occurs, the power supply for lighting of the above embodiment can rapidly respond thereto to supply a constant current of a predetermined current value to the light source 16, and yet, during a time duration that the PWM signal is at high level, maintain the current Iₒᵤₜ flowing through the light source 16 in a constant current value with high accuracy. In addition, when a transition of a PWM signal from high level to low level occurs, the power supply for lighting of the above embodiment can rapidly respond thereto to pause or stop application of the DC voltage to the light source 16 as well as to pause or stop the boosting operation of the DC/DC converter 12. Accordingly, in case the duty ratio of the PWM signal is altered, the above-stated operations are carried out at once, and hence the power supply can supply a constant current of a predetermined current value to the light source 16 during a time duration that the PWM signal is at high level from the time point when the transition of the PWM signal from low level to high level has occurred. Thus, even in case the duty ratio of the PWM signal is low, a constant current of a predetermined current value flows stably through the light source 16, and so it is possible to control or adjust luminance or quantity of light of the light source 16 with high accuracy.

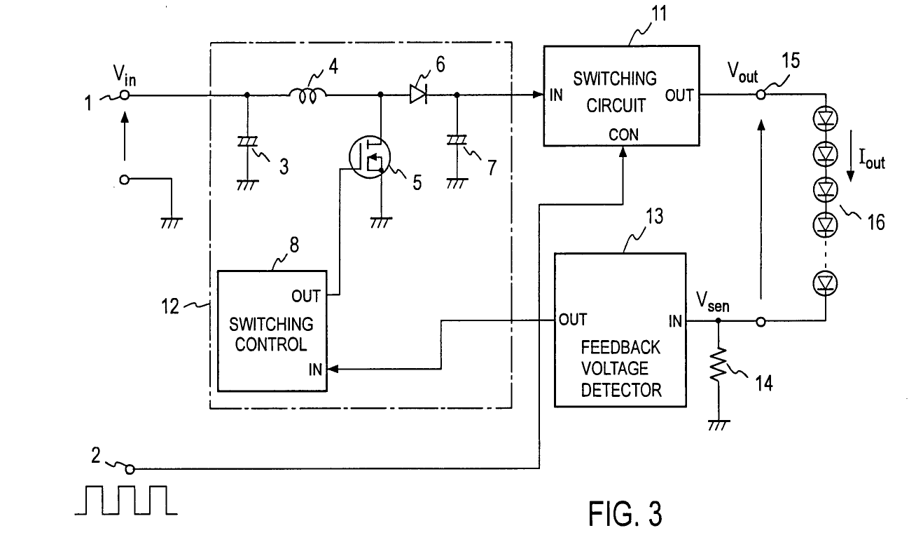

Meanwhile, in the power supply for lighting shown in FIG. 1 or FIG. 2, even though the circuit construction of the power supply is altered such that a PWM signal is applied to only the switching circuit 11 to turn on/off only the switching circuit 11 thereby to pass or break the output voltage from the DC/DC converter 12 through the switching circuit 11, it is possible to control or adjust luminance or quantity of light of the light source 16. One example of the circuit construction in such case is shown in FIG. 3. Further, in FIG. 3, elements and portions corresponding to those in FIG. 1 will be denoted by the same reference numbers or characters attached thereto, and explanation thereof will be omitted unless necessary.

In FIG. 3, when a DC voltage Vᵢₙ of a predetermined voltage value is inputted to the input terminal 1, the DC voltage Vᵢₙ is boosted, when a PWM signal applied to the PWM signal input terminal 2 is at high level as well as the switching control element 8 is in operative condition, to a DC voltage of a predetermined voltage value by the boosting operation of the DC/DC converter 12 and charged in the second capacitor 7. The DC voltage of a predetermined voltage value being charged in the second capacitor 7 is supplied to the output terminal 15 while the PWM signal is at high level so that a constant current Iₒᵤₜ of a predetermined current value flows through the light source 16, and hence it is turned on (emits light).

When the transition of the PWM signal from high level to low level occurs, the switching circuit 11 is immediately turned off so that the DC voltage being charged in the second capacitor 7 is not supplied to the output terminal 15, and hence the light source 16 is turned off at once. When the light source 16 is extinguished, the detected voltage Vₛₑₙ being supplied to the input end IN of the feedback voltage detection circuit 13 goes to zero (0) volt with a little time delay, and the switching control element 8 stops its operation with a little time delay so that the DC/DC converter 12 also stops its boosting operation with a little time delay.

When the transition of the PWM signal from low level to high level occurs, the switching circuit 11 is immediately turned on so that the DC voltage being charged in the second capacitor 7 is supplied to the output terminal 15 at once, and hence the light source 16 is instantaneously turned on. On the other hand, since the detected voltage Vₛₑₙ is applied to the feedback voltage detection circuit 13 with a little time delay, the feedback voltage detection circuit 13 outputs a feedback voltage to the switching control element 8 with a time delay. As a result, the switching control element 8 starts its operation with a time delay so that the DC/DC converter 12 also starts its boosting operation with a time delay.

As is well known, the DC/DC converter 12 performs its boosting operation by which a stable DC voltage of a predetermined voltage value is outputted, by that the voltage Vₛₑₙ detected from the current Iₒᵤₜ flowing through the light source 16 or a voltage based on the detected voltage is fed back and inputted to the switching control element 8. Since such feedback control is done, there is a time delay between detection of the voltage Vₛₑₙ and output or generation of the DC voltage Vₒᵤₜ of a predetermined voltage value. In case the switching circuit 11 is periodically turned on/off by such high frequency as on/off of the light source 16 cannot be recognized by human eyes such as a PWM signal, a time delay that is a feature of the feedback control cannot be neglected, and there occurs a problem that the DC/DC converter 12 becomes oscillating state or stops to operate. In other words, since there is a time delay between detection of the voltage Vₛₑₙ and output of the DC voltage Vₒᵤₜ of a predetermined voltage value, when the duty ratio of a PWM signal is low, the DC/DC converter 12 cannot respond to periodic change in level of the PWM signal at high frequency so that it becomes oscillating state or stops to operate.

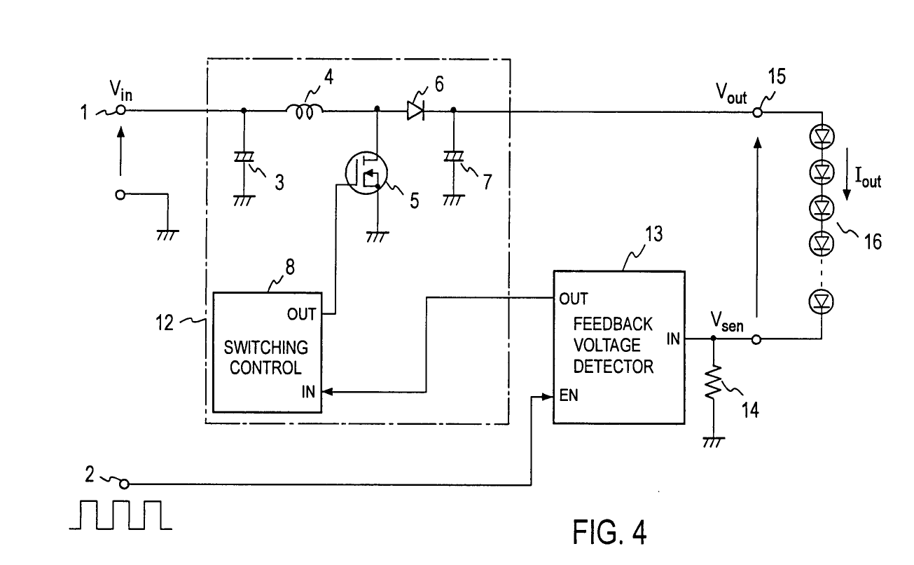

On the contrary, in the power supply for lighting shown in FIG. 1 or FIG. 2, even though the circuit construction of the power supply is altered such that a PWM signal is applied to only the feedback voltage detection circuit 13 to output the detected voltage Vₛₑₙ or a voltage based on the detected voltage, or the voltage V_{ref} for stopping the operation of the switching control element 8 from the feedback voltage detection circuit 13 in synchronism with a change in level of the PWM signal so that the DC/DC converter 12 performs its boosting operation to output a DC voltage of a predetermined voltage value or stops to perform its boosting operation, it is possible to control or adjust luminance or quantity of light of the light source 16. One example of the circuit construction in such case is shown in FIG. 4. Further, in FIG. 4, elements and portions corresponding to those in FIG. 1 will be denoted by the same reference numbers or characters attached thereto, and explanation thereof will be omitted unless necessary.

In FIG. 4, when a DC voltage Vᵢₙ of a predetermined voltage value is inputted to the input terminal 1, the DC voltage Vᵢₙ is boosted, when a PWM signal applied to the PWM signal input terminal 2 is at high level, to a DC voltage of a predetermined voltage value by the boosting operation of the DC/DC converter 12 and charged in the second capacitor 7 since a voltage signal based on the detected voltage Vₛₑₙ (usually, a voltage signal obtained by amplifying the detected voltage Vₛₑₙ) is fed back from the feedback voltage detection circuit 13 to the switching control element 8 of the DC/DC converter 12. The DC voltage of a predetermined voltage value being charged in the second capacitor 7 is supplied to the output terminal 15, and hence it is applied across the light source 16 so that a current Iₒᵤₜ of a predetermined current value flows therethrough. Thus, the light source 16 is turned on (emits light).

When the transition of the PWM signal from high level to low level occurs, the set voltage that functions to stop the operation of the switching control element 8 is immediately generated from the feedback voltage detection circuit 13 and is supplied to the input end IN of the switching control element 8, and hence the DC/DC converter 12 stops its boosting operation at once. Accordingly, since the DC voltage of a predetermined voltage value is not charged in the second capacitor 7, the light source 16 is extinguished.

When the transition of the PWM signal from low level to high level occurs, the feedback voltage detection circuit 13 instantaneously stops to output the set voltage, and the switching element 8 becomes operative condition at once so that the DC/DC converter 12 starts its boosting operation though it may be unstable. As a result, a DC voltage is charged in the second capacitor 7 and the charged DC voltage is supplied to the output terminal 15. Accordingly, a current flows the light source 16 so that it is turned on (emits light). When the light source 16 is turned on, the detected voltage Vₛₑₙ is applied to the input end IN of the feedback voltage detection circuit 13, and a voltage signal corresponding to the detected voltage Vₛₑₙ amplified by a predetermined amplification factor in the feedback voltage detection circuit 13 is fed back to the switching control element 8 of the DC/DC converter 12 with a time delay. Consequently, the switching control element 8 goes to its predetermined switching operation with a time delay so that the DC/DC converter 12 also goes to its stable boosting operation with a time delay.

As discussed above, in the power supply shown in FIG. 4, the DC voltage to be applied to the light source 16 is turned on/off only by the feedback control, and therefore, a problem does not occur that the DC/DC converter 12 becomes oscillating state or stops to operate like the power supply shown in FIG. 3. However, since there is a time delay between detection of the voltage Vₛₑₙ and output of the DC voltage Vₒᵤₜ of a predetermined voltage value, the rise of a current flowing through the light source 16 becomes slow, and when the duty ratio of the PWM signal is low, there occurs a drawback that the DC/DC converter 12 stops its boosting operation before a current flowing through the light source 16 reaches a predetermined current value. In other words, in case the power supply is constructed such that only the feedback voltage detection circuit 13 is turned on/off by the PWM signal, it is impossible that the power supply rapidly or quickly responds to periodic change in level of the PWM signal with high precision. Therefore, when the duty factor of the PWM signal is low, there occurs a disadvantage that the DC/DC converter 12 stops its boosting operation before a current flowing through the light source 16 reaches a predetermined current value so that a constant current of a predetermined current value cannot be supplied to the light source 16.

For that reason, in the above-described embodiment, the power supply is constructed such that in synchronism with the transition of the PWM signal from high level to low level, the switching circuit 11 is immediately turned off, and the set voltage V_{ref} is also instantaneously supplied from the feedback voltage detection circuit 13 to the switching control element 8 of the DC/DC converter 12 so that the DC/DC converter 12 stops its boosting operation in a moment, and that in synchronism with the transition of the PWM signal from low level to high level, the switching circuit 11 is immediately turned on thereby to supply the DC voltage of a predetermined voltage value from the second capacitor 7 to the light source 16, and a feedback voltage based on the detected voltage Vₛₑₙ is supplied from the feedback voltage detection circuit 13 to the switching control element 8 of the DC/DC converter 12 with a little time delay. As a result, there are removed a problem that that the DC/DC converter 12 becomes oscillating state or stops to operate and a disadvantage that a constant current of a predetermined current value cannot be supplied to the light source 16.

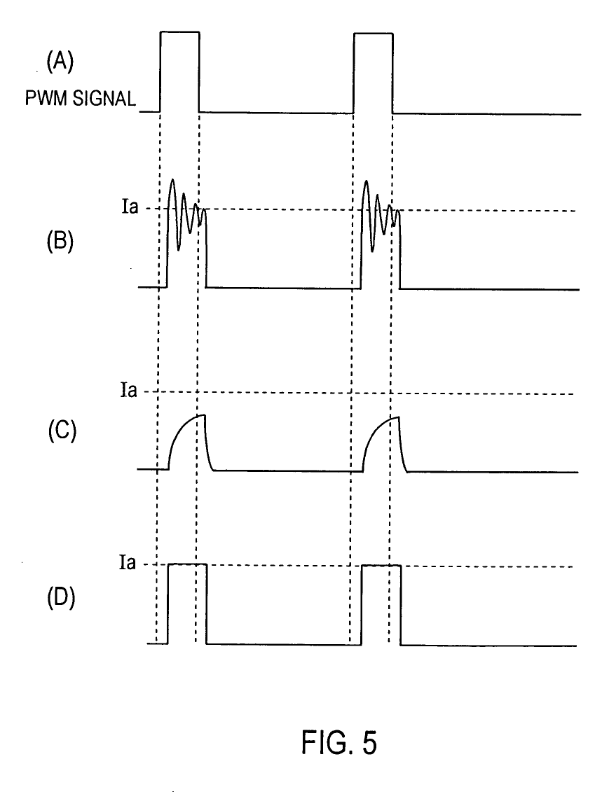

FIG. 5 is a characteristic view showing waveforms of a PWM signal, and of output currents from the power supply for lighting shown in FIGS. 1 and 2, from the power supply for lighting shown in FIG. 3 and from the power supply for lighting shown in FIG. 4 when a PWM signal the duty ratio of which is low is applied to these power supplies. FIG. 5(A) shows a waveform of the PWM signal, FIG. 5(B) shows a waveform of an output current from the power supply for lighting shown in FIG. 3, FIG. 5(C) shows a waveform of an output current from the power supply for lighting shown in FIG. 4, and FIG. 5(D) shows a waveform of an output current from each of the power supplies for lighting shown in FIGS. 1 and 2. Further, in FIGS. 5(B)-5(D), a reference character “Ia” in the ordinate denotes a current value or intensity by which luminance of each of the light emitting diodes is guaranteed.

As shown in FIG. 5(B), in the power supply for lighting shown in FIG. 3, it is seen that the responses at the leading edge (rise) and the trailing edge (fall) of the waveform of the output current are quick, but the waveform is oscillating and the DC/DC converter 12 is in oscillating state. In addition, as shown in FIG. 5(C), in the power supply for lighting shown in FIG. 4, it is seen that the response at the leading edge of the waveform of the output current is slow (the rise time is long), and the DC/DC converter 12 stops its boosting operation before a current flowing through the light source 16 reaches a predetermined current value Ia so that a constant current of a predetermined current value Ia cannot be supplied to the light source 16. On the contrary, as shown in FIG. 5(D), in the power supply for lighting according to the present invention shown in FIG. 1 or FIG. 2, it is seen that not only the responses at the leading edge and the trailing edge of the waveform of the output current are quick but also a predetermined current value Ia is maintained in stable state during the PWM signal is at high level.

Further, the specific circuit diagrams of the switching circuit 11 and the feedback voltage detection circuit 13 shown in FIG. 2 are merely examples thereof, and it is needless to say that other elements and/or circuit connections may be used.

As described above, the power supply for lighting according to the present invention is constructed such that the switching circuit for turning on/off the DC voltage outputted from the DC/DC converter and the feedback voltage detection circuit for supplying a feedback voltage to the DC/DC converter are controlled in synchronism with each other, and that in synchronism with the transition of a PWM signal from high level to low level, the switching circuit is immediately turned off as well as a set voltage is also instantaneously supplied from the feedback voltage detection circuit to the DC/DC converter thereby stopping the boosting operation of the DC/DC converter in a moment, and that in synchronism with the transition of the PWM signal from low level to high level, the switching circuit is immediately turned on thereby to supply a DC voltage of a predetermined voltage value charged in the DC/DC converter to the light source as well as a feedback voltage based on the detected voltage is supplied from the feedback voltage detection circuit to the DC/DC converter. As a result, the power supply can rapidly or quickly respond to a change in level of a PWM signal with high precision, and therefore, even the duty ratio or factor of the PWM signal is low, there are no occurrence a problem that that the DC/DC converter becomes oscillating state or stops to operate and a disadvantage that a constant current of a predetermined current value cannot be supplied to the light source.

While the present invention has been described with regard to the preferred embodiment shown by way of example, it will be apparent to those skilled in the art that various modifications, alterations, changes, and/or minor improvements of the embodiment described above can be made without departing from the spirit and the scope of the present invention. Accordingly, it should be understood that the present invention is not limited to the illustrated embodiment, and is intended to encompass all such modifications, alterations, changes, and/or minor improvements falling within the scope of the invention defined by the appended claims.

What is claimed is:

1. A power supply for lighting using a PWM (pulse width modulation) dimming system comprising:
a PWM signal input terminal to which a PWM signal is to be inputted from the outside;
a DC-to-DC converter that converts an input DC voltage to a higher DC voltage of a predetermined voltage value and is provided with means for preserving a boosted DC voltage of a predetermined voltage value;
a switching circuit that controls to pass or stop therethrough a DC voltage outputted from said DC-to-DC converter and has a control terminal to which a PWM signal is supplied from said PWM signal input terminal; and
a feedback voltage detection circuit that outputs a feedback voltage based on a current flowing through a light source or a set voltage for stopping the operation of said DC-to-DC converter and has a control terminal to which a PWM signal is supplied from the PWM signal input terminal, and wherein
said switching circuit operates such that it connects, when the PWM signal supplied to the PWM signal input terminal is at high level, its input end with its output end to output the DC voltage of a predetermined voltage value outputted from the DC-to-DC converter, and disconnects, when the PWM signal is at low level, its input end from its output end to stop outputting the DC voltage of a predetermined voltage value outputted from the DC-to-DC converter; and
said feedback voltage detection circuit operates such that it outputs, when the PWM signal supplied to the PWM signal input terminal is at high level, the feedback voltage based on a current flowing through a light source to supply it to the DC-to-DC converter, and outputs, when the PWM signal is at low level, the set voltage for stopping the operation of the DC-to-DC converter to supply it to the DC-to-DC converter.

2. The power supply as set forth in claim 1, further including means for detecting a current flowing through a light source; and wherein
when the PWM signal is at high level, a voltage signal obtained by converting a current detected by the current detection means to a voltage is inputted to the feedback voltage detection circuit so that the detection circuit supplies a feedback voltage based on the inputted voltage signal to the DC-to-DC converter; and
the switching circuit connects its input end with its output end in synchronism with the transition of the PWM signal from low level to high level, thereby to output the DC voltage being charged in the DC current preservation means of the DC-to-DC converter to a light source.

3. The power supply as set forth in claim 1, wherein the switching circuit comprises a first switching element that turns off when the PWM signal is at low level and turns on when the PWM signal is at high level; and a second switching element that turns on/off in synchronism with on/off of the first switching element, and the DC voltage outputted from the DC-to-DC converter is controlled by the second switching element to pass or stop through the switching circuit; and
the feedback voltage detection circuit comprises: a first differential amplifier having an enable terminal; and a second differential amplifier having an enable terminal, and the PWM signal is directly supplied to the enable terminal of the first differential amplifier and an inverted PWM signal of the PWM signal is supplied to the enable terminal of the second differential amplifier, and the first amplifier operates only when the PWM signal supplied to the enable terminal thereof is at high level, to output the feedback voltage based on a current flowing through a light source, and the second amplifier operates only when the PWM signal supplied to the enable terminal thereof is at high level, to output the set voltage for stopping the operation of the DC-to-DC converter.

4. The power supply as set forth in claim 2, wherein the switching circuit comprises a first switching element that turns off when the PWM signal is at low level and turns on when the PWM signal is at high level; and a second switching element that turns on/off in synchronism with on/off of the first switching element, and the DC voltage outputted from the DC-to-DC converter is controlled by the second switching element to pass or stop through the switching circuit; and
the feedback voltage detection circuit comprises: a first differential amplifier having an enable terminal; and a second differential amplifier having an enable terminal, and the PWM signal is directly supplied to the enable terminal of the first differential amplifier and an inverted PWM signal of the PWM signal is supplied to the enable terminal of the second differential amplifier, and the first amplifier operates only when the PWM signal supplied to the enable terminal thereof is at high level, to output the feedback voltage based on a current flowing through a light source, and the second amplifier operates only when the PWM signal supplied to the enable terminal thereof is at high level, to output the set voltage for stopping the operation of the DC-to-DC converter.
